(19) United States
(12) Patent Application Publication
(10) Pub. No.: US 2017/0171794 A1
(43) Pub. Date: Jun. 15, 2017

(54) METHOD AND APPARATUS FOR ACQUIRING ROUTING INFORMATION

(71) Applicant: Xiaomi Inc., Beijing (CN)

(72) Inventors: Deguo Meng, Beijing (CN); Yi Ding, Beijing (CN); Enxing Hou, Beijing (CN)

(73) Assignee: Xiaomi Inc.

(21) Appl. No.: 15/378,493

(22) Filed: Dec. 14, 2016

(30) Foreign Application Priority Data
Dec. 15, 2015 (CN) 201510937775.6

(51) Int. Cl. H04W 40/02; H04W 48/10; H04W 76/02

(52) U.S. Cl. CPC H04W 40/02; H04W 76/025; H04W 48/10; H04W 88/08

(57) ABSTRACT

A method for acquiring routing information by a first device is provided. The method includes: enabling a wireless connection function of the first device in an access point mode; establishing a wireless connection with a second device while the first device operates as an access point in the access point mode; receiving routing information sent by the second device via the wireless connection; switching the wireless connection function of the first device from the access point mode to a terminal mode; and sending the routing information to a router while the first device operates as a terminal in the terminal mode.

### CROSS-REFERENCE TO RELATED APPLICATION

This application is based upon and claims priority to Chinese Patent Application No. 201510937775.6, filed Dec. 15, 2015, the entire contents of which are incorporated herein by reference.

### TECHNICAL FIELD

The present disclosure generally relates to the field of computer processing and, more particularly, to a method and an apparatus for acquiring routing information.

### BACKGROUND

With development of electronic technology, various electronic devices emerge, such as TVs, computers, and air conditioners, and electric appliances have become smarter as a result of the development of Internet technology. Such electric appliances may be called as smart devices. The smart devices usually access Internet via a connection to a router.

### SUMMARY

According to a first aspect of the present disclosure, there is provided a method for acquiring routing information by a first device, comprising: enabling a wireless connection function of the first device in an access point mode; establishing a wireless connection with a second device while the first device operates as an access point in the access point mode; receiving routing information sent by the second device via the wireless connection; switching the wireless connection function of the first device from the access point mode to a terminal mode; and sending the routing information to a router while the first device operates as a terminal in the terminal mode.

According to a second aspect of the present disclosure, there is provided a method for providing routing information to a device, comprising: establishing a wireless connection with the device while the device operates in an access point mode; and sending routing information to the device, wherein the device establishes a connection with a router according to the routing information.

According to a third aspect of the present disclosure, there is provided an apparatus for acquiring routing information, comprising: a processor; and a memory for storing instructions executable by the processor. The processor is configured to: enable a wireless connection function in an access point mode; establish a wireless connection with a device while the apparatus operates as an access point in the access point mode; receive routing information sent by the device via the wireless connection; switch the wireless connection function from the access point mode to a terminal mode; and send the routing information to a router while the apparatus operates as a terminal in the terminal mode.

According to a fourth aspect of the present disclosure, there is provided an apparatus for providing routing information to a device, comprising: a processor; and a memory for storing instructions executable by the processor. The processor is configured to: establish a wireless connection with the device while the device operates in an access point mode; and send routing information to the device, wherein the device establishes a connection with a router according to the routing information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for acquiring routing information, according to an exemplary embodiment.

FIG. 2 is a flowchart of a method for acquiring routing information, according to another exemplary embodiment.

FIG. 3 is a flowchart of a method for providing routing information to a smart device, according to an exemplary embodiment.

FIG. 4 is a flowchart of a method for providing routing information to a smart device, according to another exemplary embodiment.

FIG. 5 is a flowchart of a method for acquiring routing information, according to another exemplary embodiment.

FIG. 6 is a block diagram of an apparatus for acquiring routing information, according to an exemplary embodiment.

FIG. 7 is a block diagram of an apparatus for acquiring routing information, according to another exemplary embodiment.

FIG. 8 is a block diagram of an apparatus for acquiring routing information, according to another exemplary embodiment.

FIG. 9 is a block diagram of an apparatus for providing routing information to a smart device, according to an exemplary embodiment.

FIG. 10 is a block diagram of an apparatus for providing routing information to a smart device, according to another exemplary embodiment.

FIG. 11 is a block diagram of a device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The embodiments of the present disclosure provide a method for acquiring routing information, which is information used for establishing a connection with a router. In the embodiments of the present disclosure, a smart device and another device are included. The smart device may be a device into which the user cannot directly input the routing information to establish a wireless connection with the router. For example, the smart device may be a smart air conditioner, a smart air purifier, a smart lamp, or the like. The other device may be a device into which the user can directly input the routing information to establish a wireless connection with the router, such as a mobile phone, a tablet computer, etc., or may be a smart device which has established a connection with the router. The embodiments of the present disclosure allow the smart device to automatically establish a wireless connection with the router without requiring the user to utilize an application program in another device, such as a mobile phone and a tablet computer, to control the smart device to establish the wireless connection with the router.

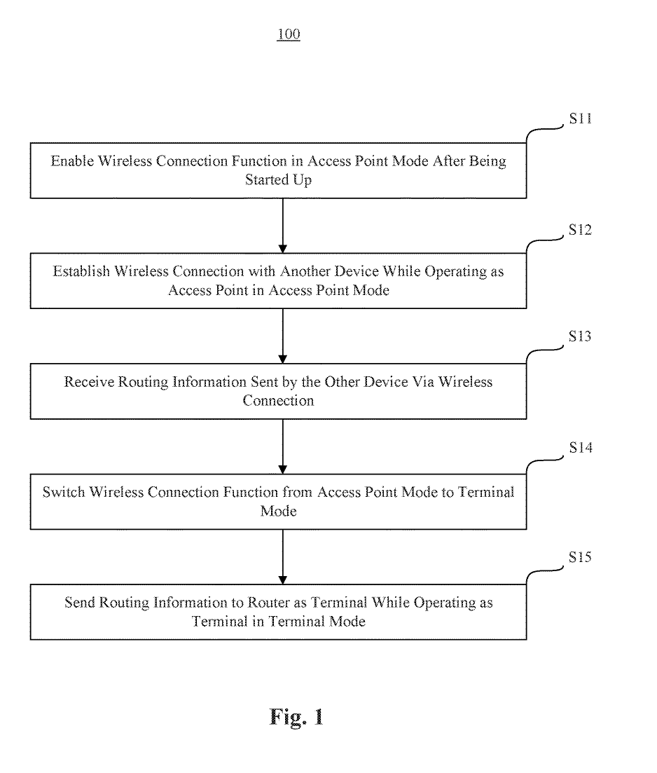

FIG. 1 is a flowchart of a method 100 for acquiring routing information, according to an exemplary embodiment. For example, the method 100 may be performed by a smart device. Referring to FIG. 1, the method 100 includes the following steps.

In step S11, after being started up, the smart device enables a wireless connection function in an access point mode.

In step S12, the smart device establishes a wireless connection with another device while operating as an access point in the access point mode.

In step S13, the smart device receives routing information sent by the other device via the wireless connection.

In step S14, the smart device switches the wireless connection function from the access point mode to a terminal mode.

In step S15, while operating as a terminal in the terminal mode, the smart device sends the routing information to a router, so as to establish a connection with the router.

In the method 100, by establishing a wireless connection with another device in an access point mode and acquiring routing information via the other device, it is unnecessary for a user to manually input the routing information into the smart device via another device. In doing so, user operations to establish the wireless connection between the smart device and the router are reduced.

In some embodiments, the routing information may be encrypted. The received routing information may be decrypted according to a preconfigured security key so as to obtain the decrypted routing information. In step S15, as the terminal, the decrypted routing information may be sent to the router. In this way, only permissible smart devices can be connected to the router, which improves a security of the routing information of the router.

In some embodiments, before establishing the wireless connection with another device as the access point, the smart device may broadcast a device identification of itself, such that the other device can detect the smart device, and then a wireless connection may be established between the smart device and the other device. In this way, it is unnecessary for the user to manually operate the other device to detect the smart device when connecting the smart device to the other device, which further reduces the number of the user operations when establishing the wireless connection between the smart device and the router.

In some embodiments, the routing information includes a service set identifier and a password. After acquiring the routing information, the smart device can connect to the router according to the routing information.

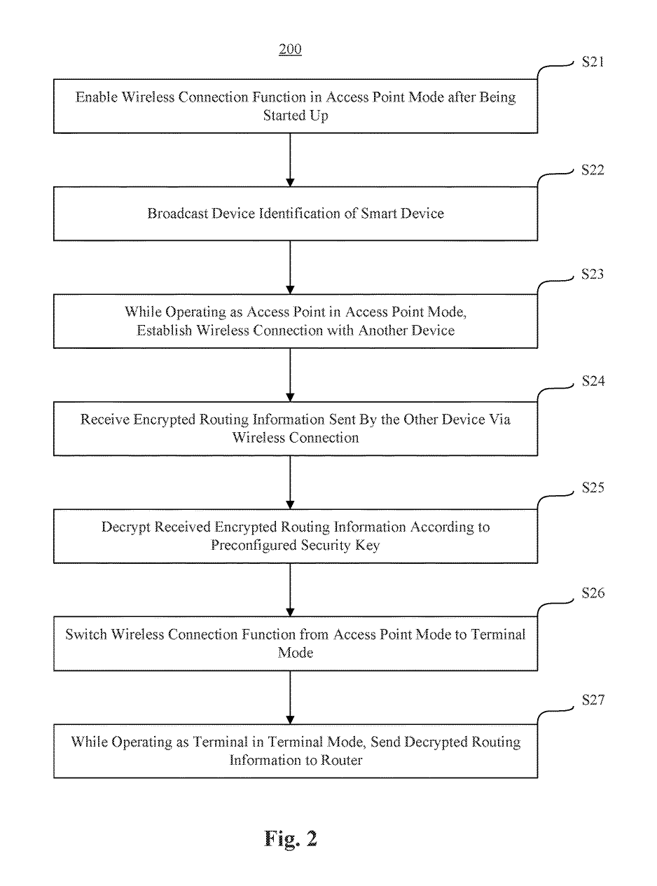

FIG. 2 is a flowchart of a method 200 for acquiring routing information, according to another exemplary embodiment. For example, the method 200 may be performed by a smart device, such as a smart camera. Referring to FIG. 2, the method 200 may include the following steps.

In step S21, after being started up, the smart device enables a wireless connection function in an access point mode.

For example, after being started up, the smart camera is used as a router, and another device may discover the smart camera and establish a wireless connection to the smart camera.

In step S22, the smart device broadcasts a device identification of the smart device.

For example, the smart camera broadcasts the device identification X1 of itself.

In step S23, while operating as an access point in the access point mode, the smart device establishes a wireless connection with another device.

For example, a mobile phone may establish a wireless connection with the smart camera via the device identification X1 broadcasted by the smart camera.

In step S24, the smart device receives encrypted routing information sent by the other device via the wireless connection. In some embodiments, the routing information may include a service set identifier and a password.

For example, after establishing a wireless connection with the mobile phone, the smart camera may receive an encrypted service set identifier and password of a router sent by the mobile phone, such as an encrypted user name and password of a user.

In step S25, the smart device decrypts the received encrypted routing information according to a preconfigured security key.

For example, the smart camera may decrypt the received encrypted user name and password of the router according to a security key preset in the smart camera before leaving the factory, so as to acquire the decrypted user name and password of the router.

In step S26, the smart device switches the wireless connection function from the access point mode to a terminal mode.

For example, after acquiring the decrypted user name and password of the router, the smart camera switches the current operation mode from the access point mode to the terminal mode. In the terminal mode, the smart camera may operate as a terminal device and establish a wireless connection with the router.

In step S27, while operating as a terminal in the terminal mode, the smart device sends the decrypted routing information to a router, so as to establish a connection with the router.

For example, the router may determine whether to establish a wireless connection with the smart camera according to the decrypted user name and password of the router sent by the smart camera. If the decrypted user name and password of the router sent by the smart camera are correct, the router may establish a wireless connection with the smart camera.

By establishing a wireless connection with another device in an access point mode acquiring the encrypted routing information via the other device, and decrypting the encrypted routing information via the preconfigured security key, it is unnecessary for a user to manually input the routing information into the smart device via the other device, which reduces the number of the user operations when establishing the wireless connection between the smart device and the router. The encryption and decryption process of the routing information improves security of the wireless connection network provided by the router.

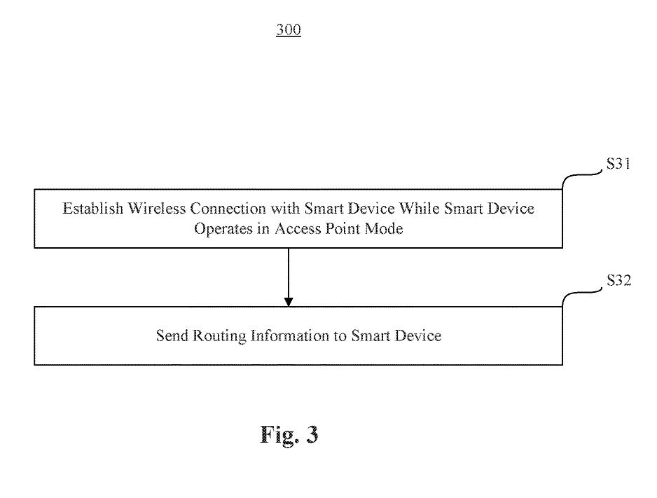

FIG. 3 is a flowchart of a method 300 for providing routing information to a smart device, according to an exemplary embodiment. For example, the method 300 may be performed by a device. Referring to FIG. 3, the method 300 includes the following steps.

In step S31, the device establishes a wireless connection with a smart device while the smart device operates in an access point mode.

In step S32, the device sends routing information to the smart device. The smart device may establish a connection with a router according to the routing information.

In some embodiments, before establishing the wireless connection with the smart device in the access point mode, the device receives a device identification broadcasted by the smart device. The device may send the device identification to a server. Subsequently, the device may receive from the server a security key corresponding to the device identification. The device may encrypt the routing information according to the received security key and send the encrypted routing information to the smart device. In this way, the routing information acquired by the smart device can be decrypted by the smart device, thereby improving the security of the routing information and the security of the smart device when being wirelessly connected to the router.

In some embodiments, the routing information includes a service set identifier and a password.

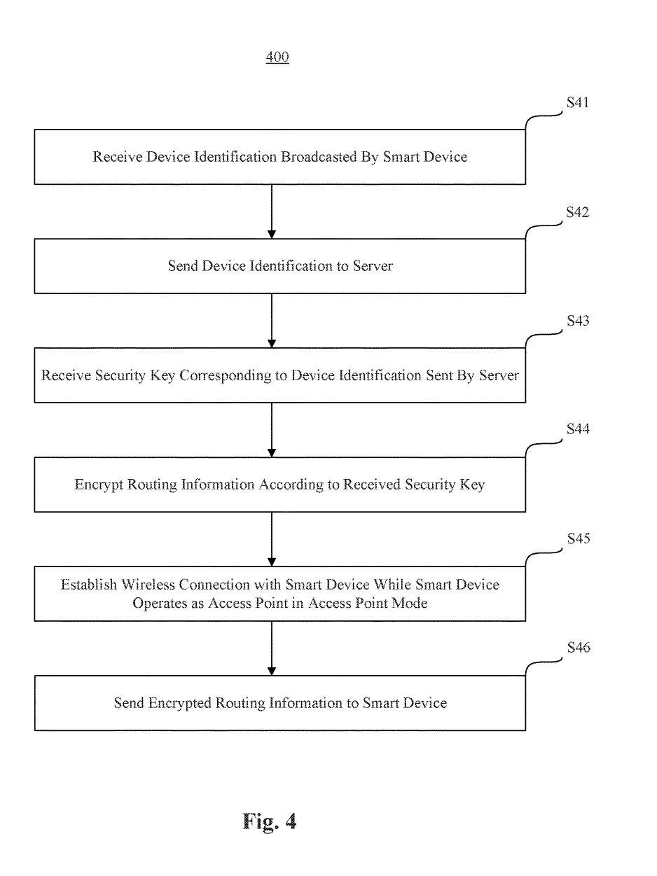

FIG. 4 is a flowchart of a method 400 for providing routing information to a smart device, according to another exemplary embodiment. For example, the method 400 may be performed by a device, such as a mobile phone, and the smart device may be a smart camera. Referring to FIG. 4, the method 400 may include the following steps.

In step S41, the device receives a device identification broadcasted by the smart device.

For example, the mobile phone may receive a device identification X1 broadcasted by the smart camera.

In step S42, the device sends the device identification to a server.

For example, the mobile phone may send the received device identification X1 of the smart camera to the server.

In step S43, the device receives a security key corresponding to the device identification sent by the server.

For example, a security key corresponding to the device identification X1 of the smart camera may be sent by the server.

In step S44, the device encrypts the routing information according to the received security key. In some embodiments, the routing information includes a service set identifier and a password for accessing a router.

For example, the mobile phone encrypts the service set identifier and the password of the router according to the received security key corresponding to the device identification X1 of the smart camera. The mobile phone may encrypt user names and passwords of one or more routers saved in the mobile phone according to the security key.

In step S45, the device establishes a wireless connection with the smart device while the smart device operates as an access point in the access point mode.

For example, the mobile phone may establish a wireless connection with the smart camera operating in an access point mode.

In step S46, the device sends the encrypted routing information to the smart device. The smart device may establish a connection with the router according to the routing information.

For example, the mobile phone sends the encrypted user name and password of the router to the smart camera. The smart camera may operate as a terminal device and send the decrypted user name and password of the router to the router. The router may determine whether to establish a wireless connection with the smart camera according to the user name and password of the router sent by the smart camera. If the user name and password of the router sent by the smart camera are correct, the router may establish the wireless connection with the smart camera.

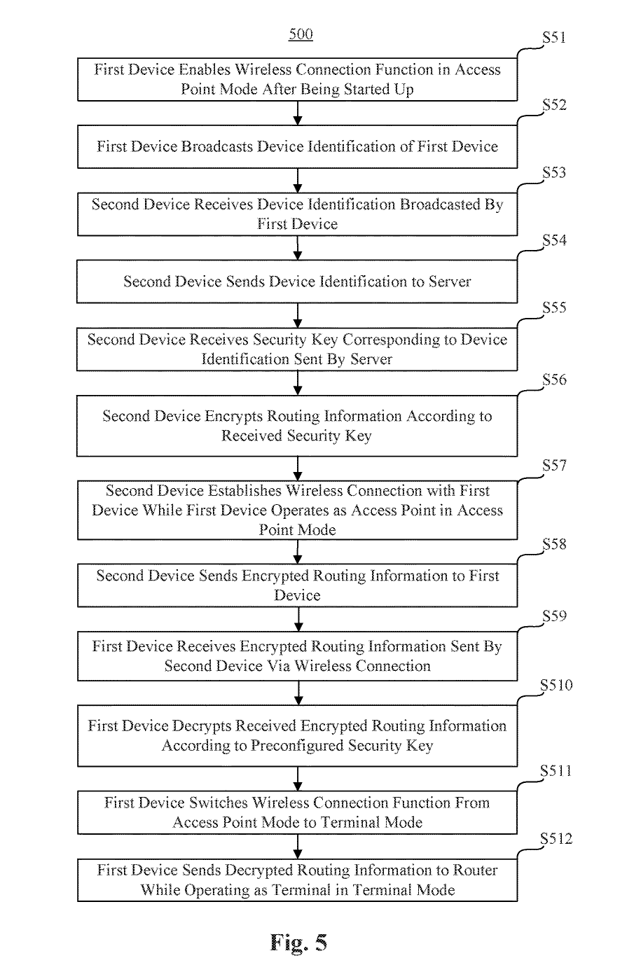

FIG. 5 is a flowchart of a method 500 for acquiring routing information, according to another exemplary embodiment. For example, the method 500 may be performed by a first device, such as a smart camera, and a second device, such as a mobile phone. Referring to FIG. 5, the method 500 may include the following steps.

In step S51, the first device enables a wireless connection function in an access point mode after being started up.

For example, a smart camera, after being started up, enables a wireless connection function in an access point mode. The smart camera operates as a router in the access point mode, and another device may discover the smart camera and establish a wireless connection with the smart camera.

In step S52, the first device broadcasts a device identification of the first device.

For example, the smart camera broadcasts a device identification X1 of itself.

In step S53, the second device receives the device identification broadcasted by the first device.

For example, the mobile phone receives the device identification X1 broadcasted by the smart camera.

In step S54, the second device sends the device identification to a server.

For example, the mobile phone sends the received device identification X1 of the smart camera to the server.

In step S55, the second device receives a security key corresponding to the device identification sent by the server.

For example, a security key corresponding to the device identification X1 of the smart camera may be obtained by the server according to the device identification X1 of the smart camera and sent to the mobile phone.

In step S56, the second device encrypts the routing information according to the received security key, where the routing information includes a service set identifier and a password for accessing a router.

For example, the mobile phone encrypts the service set identifier and the password of the router according to the received security key corresponding to the device identification X1 of the smart camera. The mobile phone may encrypt user names and passwords of one or more routers saved in the mobile phone according to the security key.

In step S57, the second device establishes a wireless connection with the first device while the first device operates as an access point in the access point mode.

For example, the mobile phone establishes a wireless connection with the smart camera operating in an access point mode.

In step S58, the second device sends the encrypted routing information to the first device.

For example, the mobile phone sends the encrypted user name and password of the router to the smart camera.

In step S59, the first device receives the encrypted routing information sent by the second device via the wireless connection. The routing information includes the service set identifier and the password.

For example, after establishing a wireless connection with the mobile phone, the smart camera receives an encrypted user name and password of the router sent by the mobile phone. For example, the user name of the router is a service set identifier of the router.

In step S510, the first device decrypts the received encrypted routing information according to a preconfigured security key.

For example, the smart camera decrypts the received encrypted user name and password of the router according to a security key preset in the smart camera before leaving the factory, so as to acquire the decrypted user name and password of the router.

In step S511, the first device switches the wireless connection function from the access point mode to a terminal mode.

For example, after acquiring the decrypted user name and password of the router, the smart camera switches the current operation mode from the access point mode to the terminal mode. In the terminal mode, the smart camera may function as a terminal device and establish a wireless connection with the router.

In step S512, the first device sends the decrypted routing information to the router while operating as a terminal in a terminal mode, so as to establish a connection with the router.

For example, the smart camera operates as the terminal device and sends the decrypted user name and password of the router to the router. The router determines whether to establish a wireless connection with the smart camera according to the decrypted user name and password of the router sent by the smart camera. If the decrypted user name and password of the router sent by the smart camera are correct, the router may establish a wireless connection with the smart camera.

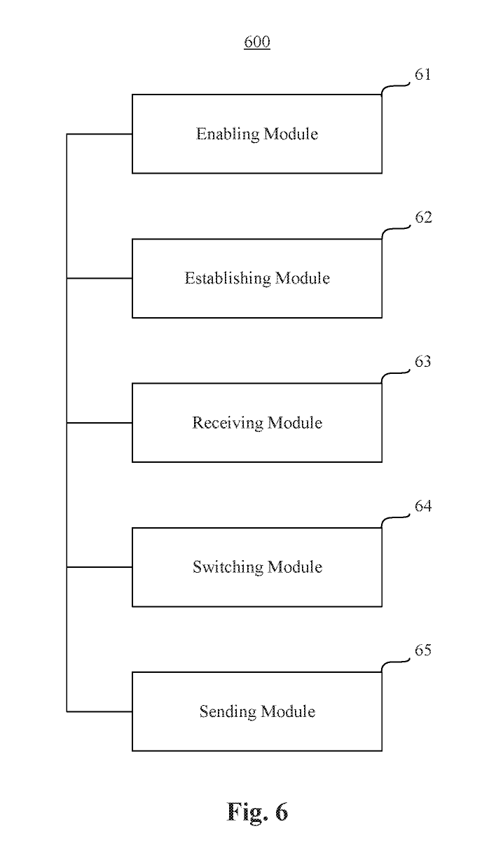

FIG. 6 is a block diagram of an apparatus 600 for acquiring routing information, according to an exemplary embodiment. The apparatus 600 may be implemented as a whole or a part of the smart device described above in connection with FIGS. 1-2 by hardware, software, or a combination thereof. Referring to FIG. 6, the apparatus 600 includes an enabling module 61, an establishing module 62, a receiving module 63, a switching module 64, and a sending module 65.

The enabling module 61 is configured to enable a wireless connection function in an access point mode after being started up.

The establishing module 62 is configured to establish a wireless connection with another device while the apparatus 600 operates as an access point in the access point mode.

The receiving module 63 is configured to receive routing information sent by the other device via the wireless connection.

The switching module 64 is configured to switch the wireless connection function from the access point mode to a terminal mode.

The sending module 65 is configured to send the routing information to a router while the apparatus 600 operates as a terminal in the terminal mode, so as to establish a connection with the router.

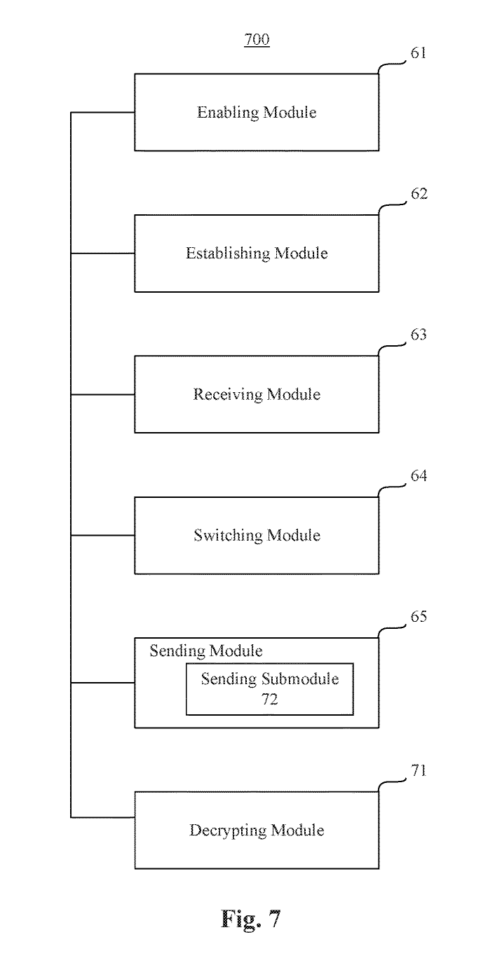

FIG. 7 is a block diagram of an apparatus 700 for acquiring routing information, according to another exemplary embodiment. The apparatus 700 may be implemented as a whole or a part of the smart device described above in connection with FIGS. 1-2 by hardware, software, or a combination thereof. Referring to FIG. 7, the apparatus 700 further includes a decrypting module 71 in addition to the enabling module 61, establishing module 62, receiving module 63, switching module 64, and sending module 65.

In some embodiments, the routing information may be encrypted, and the decrypting module 71 is configured to decrypt the received routing information according to a preconfigured security key so as to obtain the decrypted routing information.

In some embodiments, the sending module 65 includes a sending submodule 72. The sending submodule 72 is configured to send the decrypted routing information to the router while the apparatus 700 operates as the terminal in the terminal mode.

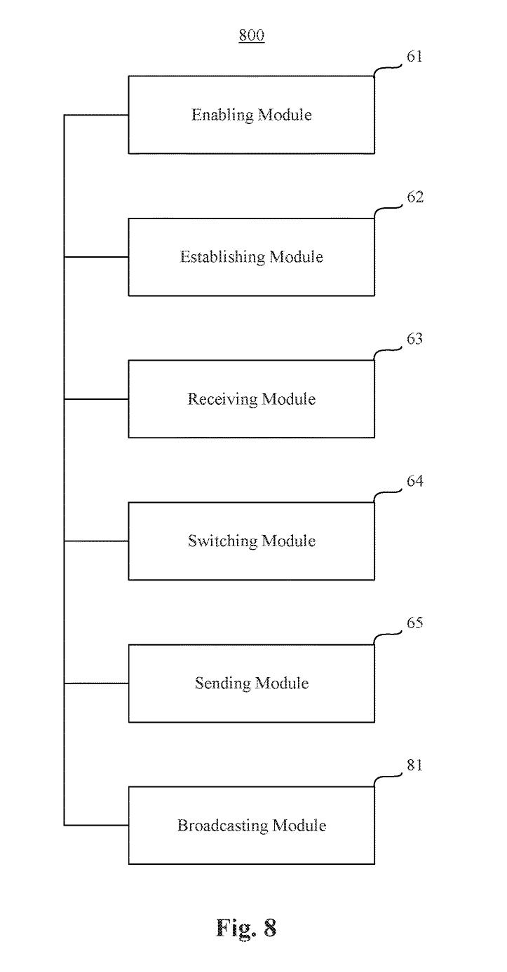

FIG. 8 is a block diagram of an apparatus 800 for acquiring routing information, according to another exemplary embodiment. The apparatus 800 may be implemented as a whole or a part of the smart device described above in connection with FIGS. 1-2 by hardware, software, or a combination thereof. Referring to FIG. 8, the apparatus 800 further includes a broadcasting module 81 in addition to the enabling module 61, establishing module 62, receiving module 63, switching module 64, and sending module 65.

The broadcasting module 81 is configured to, before establishing the wireless connection with another device as the access point, broadcast a device identification of the apparatus 800.

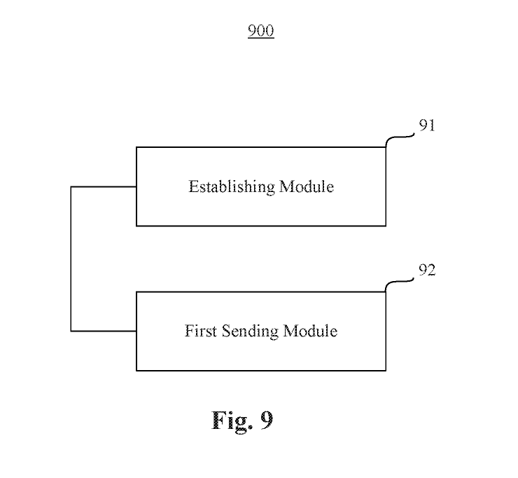

FIG. 9 is a block diagram of an apparatus 900 for providing routing information to a smart device, according to an exemplary embodiment. The apparatus 900 may be implemented as a whole or a part of the device described above in connection with FIGS. 3-4 by hardware, software, or a combination thereof. Referring to FIG. 9, the apparatus 900 includes an establishing module 91 and a first sending module 92.

The establishing module 91 is configured to establish a wireless connection with a smart device while the smart device operates as an access point in an access point mode.

The first sending module 92 is configured to send routing information to the smart device. The smart device may then establish a connection with a router according to the routing information.

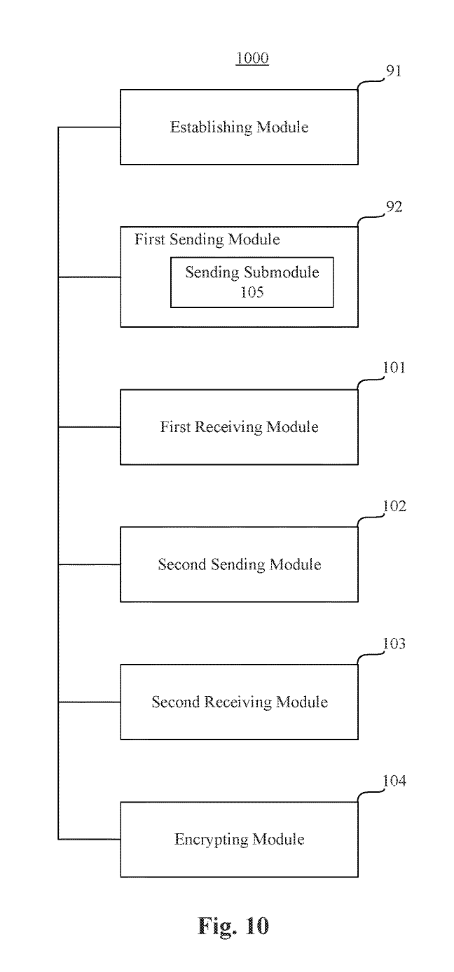

FIG. 10 is a block diagram of an apparatus 1000 for providing routing information to a smart device, according to another exemplary embodiment. The apparatus 900 may be implemented as a whole or a part of the device described above in connection with FIGS. 3-4 by hardware, software, or a combination thereof. Referring to FIG. 10, the apparatus 1000 further includes a first receiving module 101, a second sending module 102, a second receiving module 103, and an encrypting module 104 in addition to the establishing module 91 and first sending module 92.

The first receiving module 101 is configured to, before establishing the wireless connection with the smart device in the access point mode, receive a device identification broadcasted by the smart device.

The second sending module 102 is configured to send the device identification to a server.

The second receiving module 103 is configured to receive a security key corresponding to the device identification sent by the server.

The encrypting module 104 is configured to encrypt the routing information according to the received security key so as to obtain the encrypted routing information.

In some embodiments, the first sending module 92 includes a sending submodule 105. The sending submodule 105 is configured to send the encrypted routing information to the smart device.

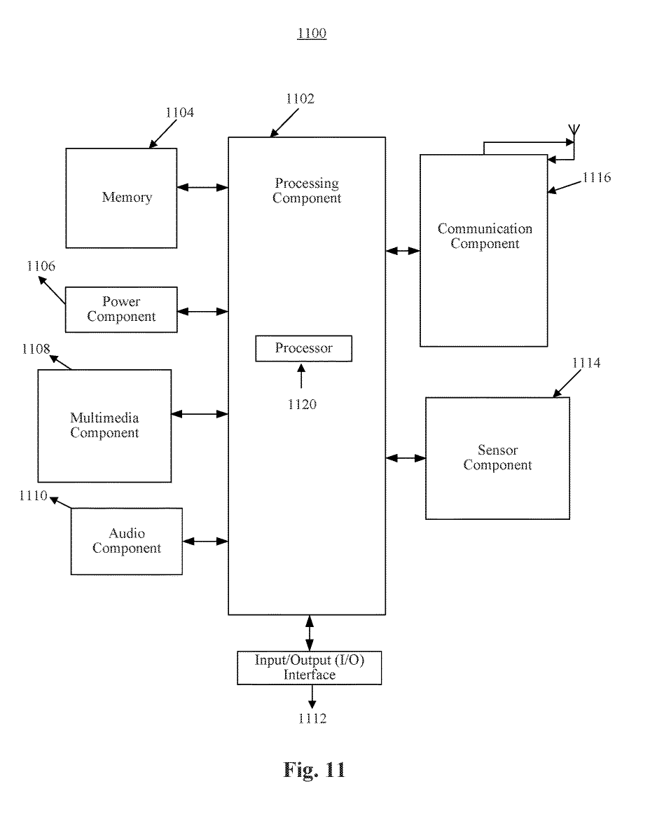

FIG. 11 is a block diagram of a device 1100, according to an exemplary embodiment. For example, the device 1100 may be the smart device acquiring routing information, as described above in connection with FIGS. 1-2, or the device providing routing information to the smart device, as described above in connection with FIGS. 3-4. For example, the device 1100 may be a smart camera, a mobile phone, a computer, a digital broadcast terminal, a messaging device, a gaming console, a tablet, a medical device, exercise equipment, a personal digital assistant, and the like.

Referring to FIG. 11, the device 1100 may include one or more of the following components: a processing component 1102, a memory 1104, a power component 1106, a multimedia component 1108, an audio component 1110, an input/output (I/O) interface 1112, a sensor component 1114, and a communication component 1116. The person skilled in the art should appreciate that the structure of the device 1100 as shown in FIG. 11 does not intend to limit the device 1100. The device 1100 may include more or less components or combine some components or other components.

The processing component 1102 typically controls overall operations of the device 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. The processing component 1102 performs various functions and data processing by operating programs and modules stored in the memory 1104. Examples of such data include instructions for any applications or methods operated on the device 1100, contact data, phonebook data, messages, pictures, videos, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 is configured to provide power to various components of the device 1100. The power component 1106 may include a power management system, one or more power sources, and/or any other components associated with the generation, management, and distribution of power in the device 1100.

The multimedia component 1108 includes a screen providing an output interface between the device 1100 and the user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures performed on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum while the device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 may include a microphone configured to receive an external audio signal when the device 1100 is in an operation mode, such as a call mode, a recording mode, and/or a voice recognition mode. The received audio signal may be further stored in the memory 1104 or transmitted via the communication component 1116. In some embodiments, the audio component 1110 may further include a loudspeaker for outputting the audio signal.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an on/off status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and/or a change in temperature of the device 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G or 3G or a combination thereof. In one exemplary embodiment, the communication component 1116 receives a broadcast signal or broadcast associated information from an external broadcast management system via a broadcast channel. In one exemplary embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and/or other technologies.

In exemplary embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1104, executable by the processor 1120 in the device 1100, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for acquiring routing information by a first device, comprising:
enabling a wireless connection function of the first device in an access point mode;
establishing a wireless connection with a second device while the first device operates as an access point in the access point mode;
receiving routing information sent by the second device via the wireless connection;
switching the wireless connection function of the first device from the access point mode to a terminal mode; and
sending the routing information to a router while the first device operates as a terminal in the terminal mode.

2. The method of claim 1, wherein the routing information is encrypted, the method further comprising:
decrypting the received routing information according to a preconfigured key;
wherein sending the routing information to the router comprises sending the decrypted routing information to the router while the first device operates as the terminal in the terminal mode.

3. The method of claim 1, further comprising:
before establishing the wireless connection with the second device, broadcasting a device identification of the first device.

4. The method of claim 1, wherein the routing information comprises a service set identifier and a password of the router.

5. The method of claim 1, wherein the first device is one of a smart air conditioner, a smart air purifier, a smart lamp, or a smart camera.

6. The method of claim 1, wherein the second device is one of a mobile phone, a tablet computer, or a device having previously established a wireless connection with the router.

7. A method for providing routing information to a device, comprising:
establishing a wireless connection with the device while the device operates in an access point mode; and
sending routing information to the device, wherein the device establishes a connection with a router according to the routing information.

8. The method of claim 7, further comprising:
before establishing the wireless connection with the device while the device operates in the access point mode, receiving a device identification broadcasted by the device;
sending the device identification to a server; receiving a key corresponding to the device identification sent by the server; and
encrypting the routing information according to the received key;
wherein sending the routing information to the device comprises sending the encrypted routing information to the device.

9. The method of claim 7, wherein the routing information comprises a service set identifier and a password of the router.

10. The method of claim 7, wherein the device is one of a smart air conditioner, a smart air purifier, a smart lamp, or a smart camera.

11. An apparatus for acquiring routing information, comprising:
a processor; and
a memory for storing instructions executable by the processor;
wherein the processor is configured to:
enable a wireless connection function in an access point mode;
establish a wireless connection with a device while the apparatus operates as an access point in the access point mode;
receive routing information sent by the device via the wireless connection;
switch the wireless connection function from the access point mode to a terminal mode; and
send the routing information to a router while the apparatus operates as a terminal in the terminal mode.

12. The apparatus of claim 11, wherein the routing information is encrypted, and wherein the processor is further configured to:
decrypt the received routing information according to a preconfigured key; and
send the decrypted routing information to the router while the device operates as the terminal in the terminal mode.

13. The apparatus of claim 11, wherein the processor is further configured to:
before establishing the wireless connection with the device, broadcast a device identification of the apparatus.

14. The apparatus of claim 11, wherein the routing information comprises a service set identifier and a password of the router.

15. The apparatus of claim 11, being one of a smart air conditioner, a smart air purifier, a smart lamp, or a smart camera.

16. The apparatus of claim 11, wherein the device is one of a mobile phone, a tablet computer, or a device having previously established a wireless connection with the router.

17. An apparatus for providing routing information to a device, comprising:
a processor; and
a memory for storing instructions executable by the processor;
wherein the processor is configured to:
establish a wireless connection with the device while the device operates in an access point mode; and
send routing information to the device, wherein the device establishes a connection with a router according to the routing information.

18. The apparatus of claim 17, wherein the processor is further configured to:
before establishing the wireless connection with the device, receive a device identification broadcasted by the device;
send the device identification to a server;
receive a key corresponding to the device identification sent by the server;
encrypt the routing information according to the received key; and
send the encrypted routing information to the device.

19. The apparatus of claim 17, wherein the routing information comprises a service set identifier and a password of the router.

20. The apparatus of claim 17, wherein the device is one of a smart air conditioner, a smart air purifier, a smart lamp, or a smart camera.
